(19) United States
(12) Patent Application Publication
(10) Pub. No.: US 2005/0021824 A1
(43) Pub. Date: Jan. 27, 2005

(54) Systems and methods transmitting graphical data

(76) Inventors: Daryl E. Anderson, Corvallis, OR (US); Peter Fricke, Corvallis, OR (US); Andy Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/617,001

(22) Filed: Jul. 9, 2003

(51) Int. Cl. G06F 15/16

(52) U.S. Cl. 709/232

(57) ABSTRACT

Disclosed are systems and methods for transmitting graphical data via a communication line. For example, in one embodiment, a system includes means for receiving voice data, means for generating graphical data representative of a user input, and means for simultaneously transmitting the voice data and information representative of the generated graphical data via a communication line such that a bandwidth of the communication line is not exceeded.

### BACKGROUND

With today's communications capabilities, geographically-separated persons can share more information than ever. For example, not only can such persons speak with each other on the telephone, they can also send files and/or Web site links to each other via email while carrying on a conversation. Accordingly, information contained in the files or accessible through the link can be simultaneously shared and discussed while still speaking with each other on the telephone.

Such functionality is beneficial in several situations. For example, if the persons are co-workers discussing a design project, it may be helpful for them to share files that contain drawings or images of the object being designed. To cite another example, if one person is giving driving directions to someone, that person can send an hyperlink to a Web page (e.g., MapQuest™ page) that contains detailed textual directions and/or a map. In other cases, persons may wish to share and discuss photographs of friends and family.

Although email provides a way to share information while speaking with someone on the telephone, the email medium has limitations. For one, the persons can typically only share existing files or addresses of existing Web sites. Therefore, if a first person wishes to create graphical data (e.g., a sketch of a proposed design) and share it with a second person while speaking with them, the first person will need to access a graphics program, create a drawing, store the drawing, create an email message, attach the drawing file to the email, and send the email. Moreover, to view the graphical data, the second person will need to access his email program, open the email message, open the attachment (assuming that user has the same graphics program as the first user), and then view the graphical data.

In view of the above, a device with which graphical data created (i.e. drawn or sketched) by one person could be shared nearly real time with another person while the two persons carry on a telephone conversation would be desirable. For example, desirable would be a device with which graphical data could be transmitted along with voice data using the same telephone line. To implement such a device, however, the rate of data transfer must be limited due to the limited bandwidth of telephone systems (i.e. plain old telephone systems (POTS)) to ensure that the voice signals transmitted across the telephone line, or the graphical data signals, are not lost during transmission. Therefore, systems and methods must be developed for relatively low-bandwidth transmission of graphical data.

### SUMMARY

Disclosed are systems and methods for transmitting graphical data. For example, in one embodiment, a system includes means for receiving voice data, means for generating graphical data representative of a user input, and means for simultaneously transmitting the voice data and information representative of the generated graphical data via a communication line such that a bandwidth of the communication line is not exceeded.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system through which voice data and graphical data can transmitted via the same communication line.

FIG. 2 is a block diagram of an embodiment of a sketchpad device shown in FIG. 1.

FIG. 3 is a flow diagram that illustrates a first embodiment of a method for transmitting graphical information via a communication line.

FIG. 4 is a flow diagram that illustrates a second embodiment of a method for transmitting graphical data via a communication line.

FIG. 5 is a flow diagram that illustrates an embodiment of a method for displaying graphical data generated in relation to received data points.

FIG. 6A is a schematic view of graphical data entered on a first sketchpad device.

FIG. 6B is a schematic view of discrete data points that represent the graphical data shown in FIG. 6A.

FIG. 6C is a schematic view of line segments that connect the data points shown in FIG. 6B.

FIG. 7 is a flow diagram that illustrates a third embodiment of a method for transmitting graphical information via a communication line.

FIG. 8 is a schematic view of sketchpad device data points to illustrate an implementation of the method of FIG. 7.

### DETAILED DESCRIPTION

As identified above, a device with which graphical data can be transmitted, nearly real time as it is created, along with voice data using the same communication (e.g., telephone) line would be desirable. Disclosed herein is a sketchpad device that connects between a telephone and a telephone network that can be used to create such graphical data and transmit it via the telephone network to another. To avoid loss of data (voice and/or graphics), the rate of graphical data transfer from the sketchpad device is limited so as to provide relatively low-bandwidth transmission of graphical data.

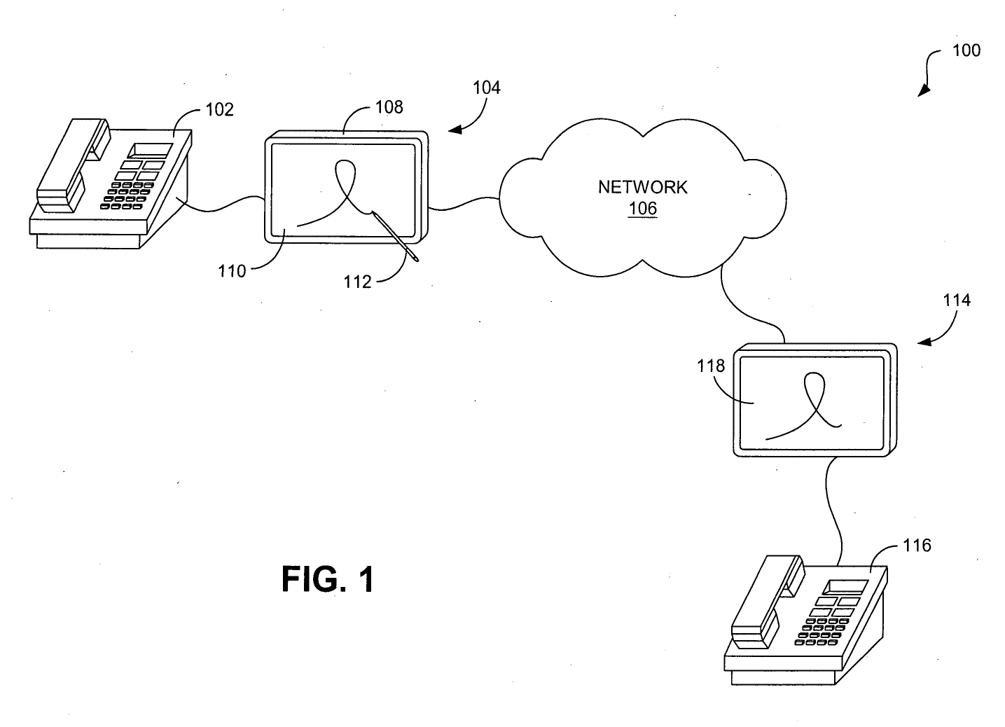

Referring now in more detail to the figures in which like numerals identify corresponding parts, FIG. 1 illustrates an example system 100 in which graphical data can be transmitted via a telephone line while the user carries on a conversation with another using that telephone line. As indicated in FIG. 1, the system 100 generally comprises a first telephone 102 and a first sketchpad device 104. The first telephone 102 can, as indicated in the figure, comprise a stationary phone that is designed to plug into a home or office telephone wall jack to access a telephone network 106.

The sketchpad device 104 is connected to the first telephone 102 as well as the telephone network 106 so as to be interposed between the telephone and the network. With this configuration, analog voice data input into the telephone 102 is received by the sketchpad device 104 and relayed on to the network 106. The sketchpad device 104 includes a device housing 108 that frames a display 110 with which graphical data can be viewed and entered. By way of example, the display 110 comprises a touch-sensitive liquid crystal display (LCD) with which graphical data may be entered using a stylus 112 or other writing/drawing tool. Although a touch-sensitive display has been explicitly identified, the display 110 can comprise any graphical display device with which graphical data may be entered.

As is further depicted in FIG. 1, a second sketchpad device 114 and telephone 116 can be also be connected to the telephone network 106. Accordingly, if a telephone connection has been established between the two telephones 102 and 116, graphical data can be transmitted from one sketchpad device (e.g., device 104) to the another sketchpad device (e.g., device 114) and shown on a display 118 of the other sketchpad device. In addition, graphical data can be transmitted in the reverse direction in a similar manner such that both parties may view and modify the same graphical data as if they were both drawing on the same piece of paper.

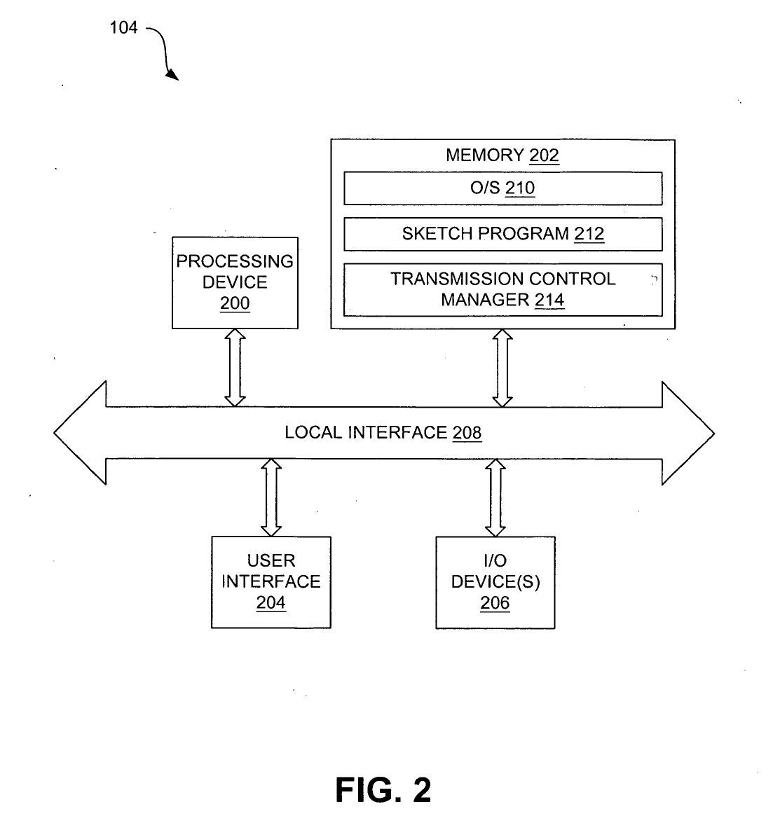

FIG. 2 is a block diagram illustrating an example architecture for the sketchpad device 104 shown in FIG. 1. Notably, the sketchpad device 114 may be identical to the sketchpad device 104 in which case the architecture shown in FIG. 2 also applies to the sketchpad device 114. As indicated in FIG. 2, the sketchpad device 104 comprises a processing device 200, memory 202, a user interface 204, and one or more input/output (I/O) devices 206. Each of these components is connected to a local interface 208 that, by way of example, comprises one or more internal buses.

The processing device 200 is adapted to execute commands stored in memory 202 and can comprise a microprocessor, one or more application-specific integrated circuits (ASICs), a plurality of suitably configured digital logic gates, and other electrical configurations comprised of discrete elements both individually and in various combinations to coordinate the overall operation of the sketchpad device 104.

The memory 202 can include any one or a combination of volatile memory elements (e.g., random access memory (RAM), static RAM (SRAM), dynamic RAM (DRAM), etc.) and nonvolatile memory elements (e.g., Flash memory, hard disk, read only memory (ROM), etc.).

The user interface 204 comprises the interface tools with which the device settings can be changed and through which the user can communicate commands to the sketchpad device 104. Moreover, the user interface 204 includes the display 110 identified in FIG. 1. In addition to the display 110, the user interface 204 may comprise one or more keys and/or buttons with which the operation of the sketchpad device 106 can be controlled. As noted above, the display 110 may comprise, for example, a touch-sensitive LCD.

The I/O devices 206 comprise any component used to transmit and/or receive graphical data (as well as voice data received from the telephone 102) over the network 106. By way of example, the I/O devices 208 include a device that can communicate both inputs and outputs, for instance, a modulator/demodulator (e.g., modem). In embodiments in which the telephone network 106 comprises a wireless telephone network, the I/O devices 206 may comprise a radio frequency (RF) transceiver. In addition, the I/O devices 206 include an input device, such as a phone jack through which analog voice data can be received from the telephone 102.

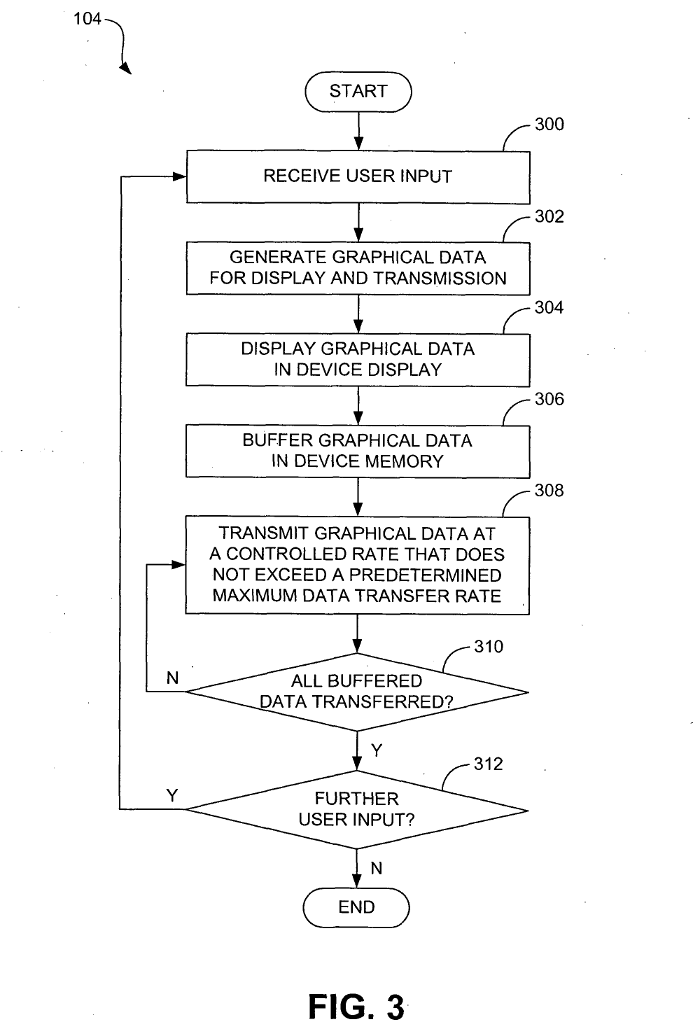

The memory 202 includes various programs (in software and/or firmware) including an operating system 210 that contains the various commands used to control the general operation of the sketchpad device 104. In addition, the memory 202 includes a sketch program 212 that is used to detect and identify user input on the display 110 and generate graphical data reflective of that user input. Furthermore, the memory 202 comprises a transmission control manager 214 that facilitates transmission of graphical data to another device (e.g., another sketchpad device). As is described in the following, the transmission control manager 214 is configured to limit the rate at which the graphical data is transferred to the other device to avoid loss of voice or graphical data during transmission. Example modes of data transfer are discussed in relation to FIGS. 3-8.

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can used by or in connection with an instruction execution system, apparatus, or device, such as a computer-based system, processor-containing system, or other system that can fetch the instructions from the instruction execution system, apparatus, or device and execute the instructions.

Example systems having been described above, system operation will now be discussed in relation to various flow diagrams. Any process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

As described above, it is desired to limit the amount of graphical data that is transmitted from the sketchpad device 104 to avoid losing voice or graphical data in the transmission. In a first method, graphical data is buffered on the sketchpad device 104, and metered out at a predetermined maximum data transfer rate. FIG. 3 describes an example mode of transmission according to such a method.

Beginning with block 300 of FIG. 3, the sketchpad device 104 receives a user input. By way of example, the user input comprises a line or a portion of a line drawn by the user on the display 110 using the stylus 112. Irrespective of the manner in which the input is received, the sketchpad device 104 (and more particularly the sketch program 212, FIG. 2) generates graphical data reflective of the user input for display in the device display 110 and transmission to another device, as indicated in block 302. By way of example, the sketchpad device 104 generates control commands that control the activation of display pixels to emulate an actual line that could have been, for instance, drawn with a pen on a piece of paper. Once the graphical data is generated, it is displayed in the device display 110, as indicated in block 304.

As the graphical data is generated and displayed, the graphical data is buffered in device memory 202, as indicated in block 306. By way of example, the data is buffered in DRAM contained within the sketchpad device 104. Due to this buffering, relatively small amounts of data may be periodically transmitted to limit the data transfer rate to a rate at which loss of voice or graphical data due to the limited bandwidth of the telephone network 106 is less likely. Accordingly, with reference to block 308, the graphical data is transmitted at a controlled rate (under the control of the transmission control manager 214) that does not exceed a predetermined maximum data transfer rate. By way of example, the maximum data transfer rate is set to approximately 2 kilobits per second.

Because the graphical data is transmitted at a relatively slow rate, not all of the buffered graphical data is transmitted at once. Instead, relatively small portions of graphical data are transmitted at a time, along with the voice data received from the telephone 102. Notably, the graphical data is converted into an analog signal prior to such transmission to enable transfer via a telephone line (i.e. POTS line). Optionally, an indication can be provided to the user entering the input that communicates to that user what portion of the input has been transmitted and/or what portion of the input is currently visible to the recipient. By way of example, the indication can comprise a different color or grayscale, a different line thickness, or the like. In such a case, the original input lines, or the indication (e.g., different color or line thickness), can be removed or gradually faded away from view after passage of a given period of time.

With reference next to decision block 310, the sketchpad device 104, and more particularly the transmission control manager 214, determines whether all of the buffered data has been transferred. If not, flow returns to block 308 at which controlled data transmission continues. Once all data has been transferred, however, flow continues to decision block 312 at which the sketchpad device 104 (under the control of the sketch program 212) determines whether further user input is detected. Notably, this determination typically occurs simultaneous to the buffering and transmitting described above. If there is more user input (e.g., other lines drawn), flow returns to block 300 at which the input is received and the above-described process is repeated. If not, however, for instance if the user has no more graphical data to show the recipient, flow for the session is terminated.

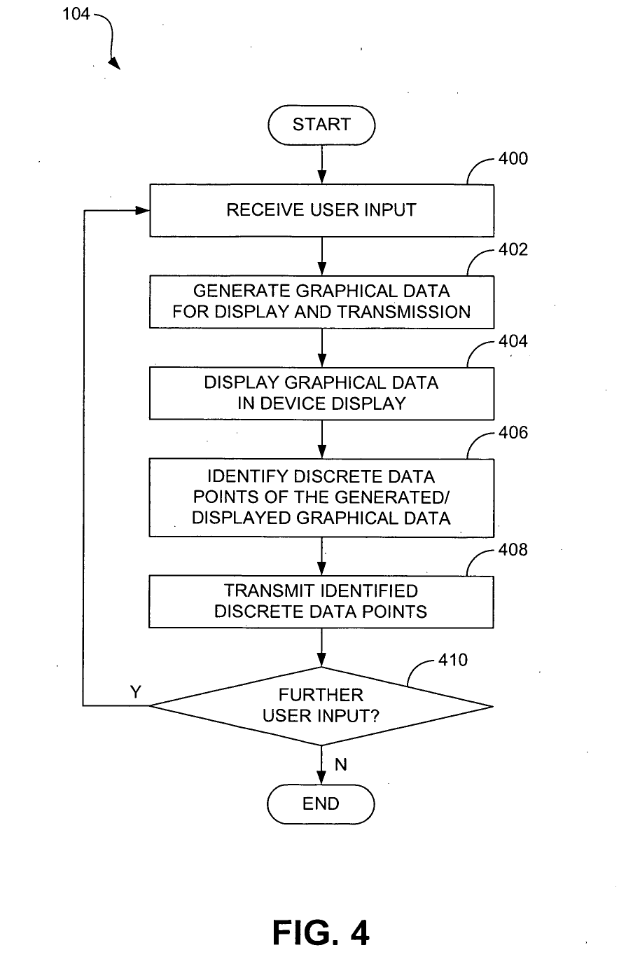

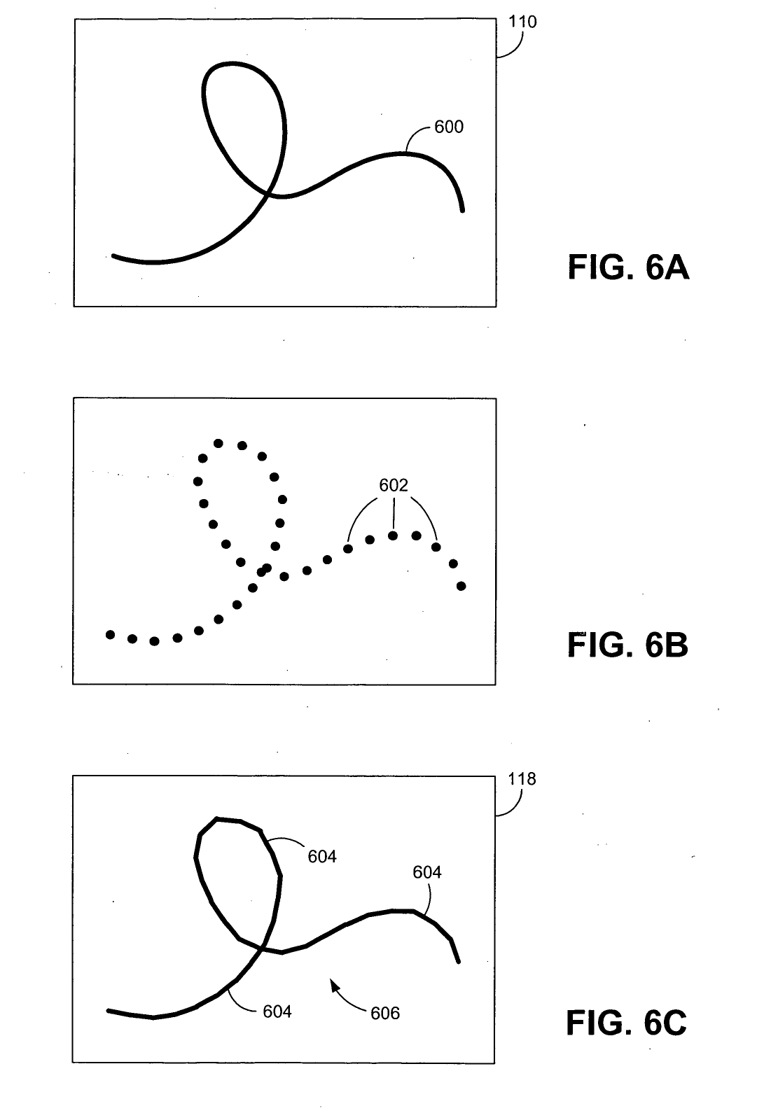

FIG. 4 describes a second mode of transmitting graphical data. Beginning with block 400 of FIG. 4, the sketchpad device 104 receives a user input that, again, can comprise a line or a portion of a line drawn by the user on the display 110 using the stylus 112. FIG. 6A illustrates an example of such a line. As shown in this figure, the user can have, for instance, entered a curved line 600 in the display 110 of the first sketchpad device 104. As the input is received, the sketchpad device 104 generates graphical data for display and transmission, as indicated in block 402 and, as indicated in block 404, displays that data in the device display 110.

During the generation and display of the graphical data, the transmission control manager 214 identifies discrete data points of the graphical data that represent the user input as indicated in block 406. FIG. 6B illustrates an example collection of such data points. As indicated in that figure, a plurality of data points 602 are merely provided that outline the curved line 600 input by the user. Notably, these data points 602 are merely representative of the points that the transmission control manager 214 identifies, and the data points are not actually displayed to the user. By way of example, each data point 602 comprises the information that would be represented with one or a group of display pixels.

The data points 602 can be identified in a variety of ways. In one method, the data points are identified on a periodic basis in which a data point is identified for every period, t, during user input. For instance, one data point can be identified for every 1/40 of a second of user input. Alternatively, the data points 602 can be obtained on a line length basis such that a data point is identified for every given length, x, of user input. For instance, one data point can be identified for every centimeter to quarter-inch of user input.

Returning to FIG. 4, as the discrete data points are identified, they are transmitted, as indicated in block 408. More specifically, information that describes the data points (address information) is transmitted. In that only discrete data points of the entire graphical data generated by the sketchpad device 104 and displayed in the device display 110 are transmitted, a relatively small data transfer rate is achieved. Referring next to decision block 410, the sketchpad device 104 determines whether there is further user input. If so, flow returns to block 400 at which the input is received. If not, flow for the session is terminated. As in the embodiment described in relation to FIG. 4, an indication can optionally be provided to the user that communicates what portion of the input has been transmitted and/or what portion of the input is currently visible to the recipient (e.g., on device 114). Again, the indication can comprise, for instance, a different color or grayscale, a different line thickness, or the like.

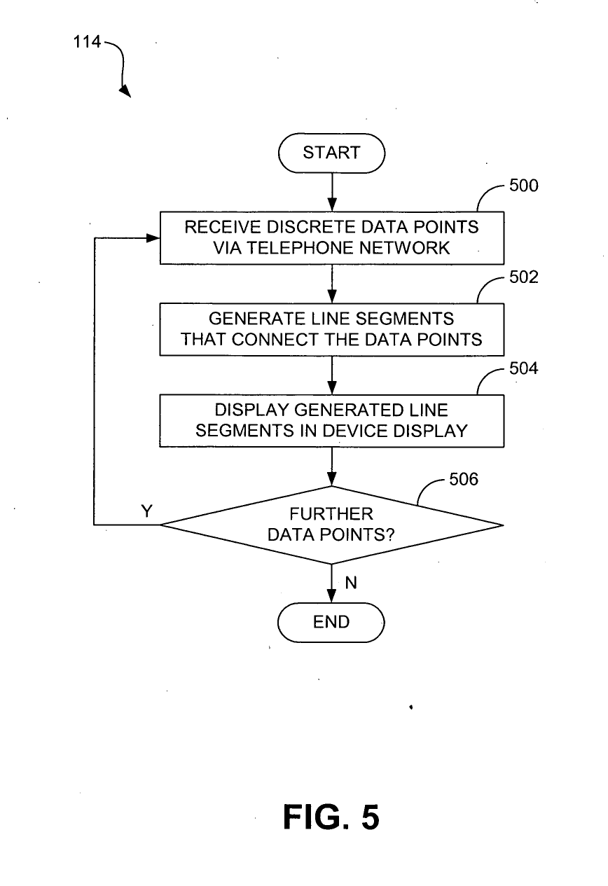

FIG. 5 describes an example of receipt of the discrete data points transmitted in FIG. 4, and display of graphical data in the device display of the receiving device (e.g., sketchpad device 116) that is based upon the received data points. With reference to block 500, the data points are received via the telephone network 106. From these data points, line segments are generated (e.g., by the sketch program of the sketchpad device 116) that “connect” the received data points, as indicated in block 502. By way of example, these line segments are straight line segments that, when connected end to end, approximate the curved line 600 (or other feature) input by the user on the sketchpad device 104.

The line segments are created by designating a first data point as a start point, designating a second data point as an end point, and then determining a straight line that connects the start and end points. This process is then repeated by using the end point as a new start point, and designating a new end point. To ensure correct connection of data points, the start and end points are designated with reference to the order in which the data points were received. Additionally, various control commands (e.g., control bits) can be transmitted from the sending sketchpad device 104 to indicate the end of a given user-entered line and the beginning of a new line to avoid connecting data points that pertain to different inputs (e.g., separate written block letters).

Once the line segments have been generated, the segments are displayed in the display of the recipient device to enable the recipient user to see what the sending user drew, as indicated in block 504. FIG. 6C illustrates an example of such line segments 604 that together form a generally curved line 606 that approximates the input curved line 600 (FIG. 6A).

The smoothness of the resultant line depends upon the number of data points, and therefore the number of line segments, that are used to create the line. Accordingly, if a relatively large amount of bandwidth is available, a relatively large number of data points may be transmitted and therefore used to obtain a relatively smooth line. If, on the other hand, less bandwidth is available, fewer data points may be transmitted to ensure that all transmitted data (voice and graphics) is received by the recipient. In the latter case, or if the sketchpad device 104 is preconfigured to transmit only at a relatively low data transfer rate, better results (i.e. smoother lines) may be obtained through an iterative process (see block 504). For example, the transmission control manager 214 can, as described above in relation to block 306 of FIG. 3, buffer all generated graphical data but, as described in relation to block 406 of FIG. 4, still only identify discrete data points of that graphical data for transmission. In some embodiments, improved results can be achieved by approximating the input curved line 600 using a spline curve that is fit over the transmitted data points. Such a spline curve may provide a more natural look than the segmented lines described above.

In such a case a relatively rough approximation of the original user input is initially provided to the recipient. Next, the transmission control manager 214 can identify a further group of discrete data points, for instance single points located halfway between the previously identified data points, and then transmit those data points to the recipient. In that two sets of data points are provided to the recipient device, twice as many line segments may be used to approximate the user-input line, thereby improving the graphical representation shown to the recipient. If this procedure is performed repeatedly in an iterative manner (i.e., group after group of new discrete data points are transmitted and used to generate new, shorterline segments), the quality of the graphical representation will continue to improve until, ultimately, all of the graphical data generated on the sending sketchpad device 104 are transmitted, and then displayed on the recipient device (e.g., sketchpad device 116) such that the sender and the recipient may view the same graphical data.

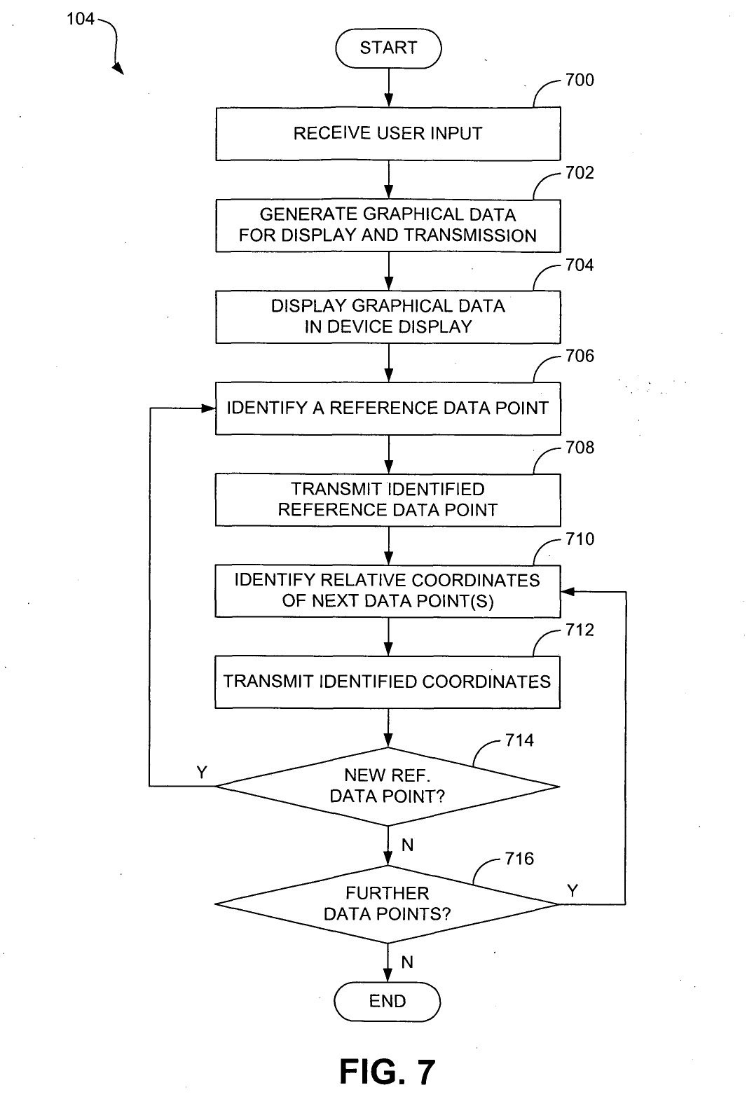

FIG. 7 describes a third mode of transmitting graphical data. Beginning with block 700 of FIG. 7, the sketchpad device 104 again receives a user input entered into the display 110. As the input is received, the sketchpad device 104 generates graphical data, as indicated in block 702, that, as indicated in block 704, it displays in the device display 110.

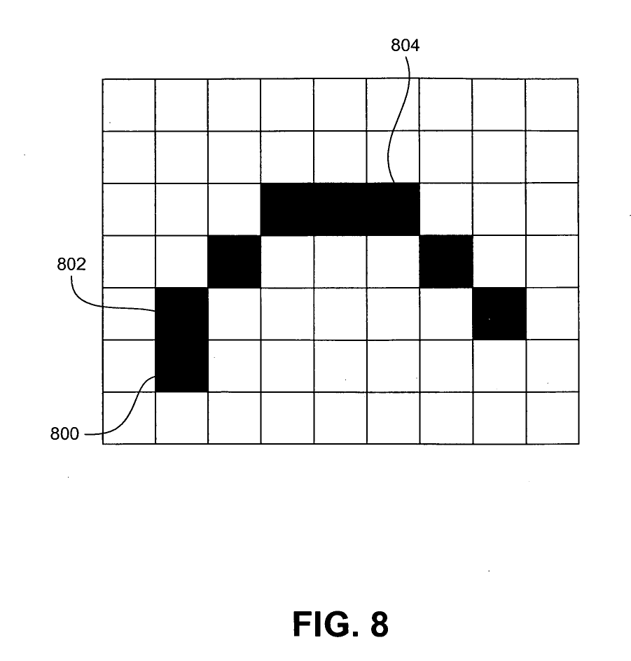

During the generation and display of the graphical data, the transmission control manager 214 identifies a reference data point (e.g., a pixel or group of pixels), as indicated in block 706, in relation to which other data points will be described. The reference data point may comprise, for instance, the first data point of a new line that is input by the user. FIG. 8 illustrates an example of data points that, in this example, comprise individual display pixels (identified in black). As indicated in that figure, the reference data point 800 is the first of a series of several data points.

Returning to FIG. 7, information describing the reference data point is transmitted to the recipient device, as indicated in block 708. For example, all data that defines the data point, as well as control data that identifies the data point as the current reference data point, are transmitted. Next, the transmission control manager 214 identifies the relative coordinates of the next data point(s) in the series, as indicated in block 710. Specifically, the relative coordinates of the next data point or points “in line” is/are identified. With reference back to the example of FIG. 8, the next data point after the reference data point 800 is data point 802. In this case, the relative x and y coordinates would be: (0x, +1y). In similar manner, data point 804 shown in FIG. 8 would have the relative x and y coordinates: (+4x, +3y).

Next, with reference to block 712 of FIG. 7, the transmission control manager 214 facilitates transmission of the identified relative coordinates of the next data point(s) to the recipient device. Significantly, these coordinates may be identified using far fewer bits that would be necessary to fully describe the data point separately. By way of example, the relative coordinates of the next data point can be described using only four bits, i.e., two bits for the x coordinate and two bits for the y coordinate.

Referring next to decision block 714, the sketchpad device 104 determines whether a new reference data point is to be used. This determination can be made in relation to whether the user has picked up the writing/drawing tool (e.g., stylus 112) utensil from the display 110 (thereby indicating the end of the entered line) and/or the distance away from the reference point that the input is being received. In the first case, the new reference data point may be the first data point of the next input line. In the second case, a new reference data point may be required if the relative distance away from the original reference data point would require a greater number of bits than are available to describe this distance (e.g., greater than 10 data points in the x and/or y directions). In such a case, another one of the data points in the series may be designated as the new reference data point, and later data points identified by their coordinates relative to the new reference point. In another implementation, a new reference data point can be automatically designated every so many transmitted data points as a means of avoiding the distance problem. For instance, every 10th data point may be described by an actual address.

If, at decision block 714, a new reference data point is to be used, flow returns to block 706. If not, however, flow continues to block 716 at which the sketchpad device 104 determines whether there is at least one other data point to describe, flow returns to block 710 and the relative coordinates of that next data point are identified and transmitted. If, on the other hand, no other such data points exist, flow is terminated. Once again, as in the embodiments described in relation to FIGS. 4 and 5, an indication can optionally be provided to the user that communicates what portion of the input has been transmitted and/or what portion of the input is currently visible to the recipient.

1. A method for transmitting graphical data via a communication line, comprising:
generating graphical data representative of a user input;
buffering the graphical data in memory; and
transmitting portions of the graphical data over the communication line to a remote device at a controlled rate that does not exceed a predetermined maximum data transfer rate at which a bandwidth of the communication line would be exceeded.

2. The method of claim 1, wherein generating graphical data comprises generating graphical data representative of a line entered using a touch-sensitive display.

3. The method of claim 1, wherein transmitting portions of the graphical data comprises transmitting portions of the graphical data to such that no more that approximately 2 kilobits of graphical data is transmitted per second.

4. The method of claim 1, further comprising receiving voice data input via a telephone.

5. The method of claim 4, further comprising simultaneously transmitting the voice data over the communication line along with the portions of graphical data.

6. A method for transmitting graphical data via a communication line, comprising:
generating graphical data representative of a user input;
identifying discrete data points of the generated graphical data; and
transmitting only the identified discrete data points over the communication line to a remote device such less than all of the generated graphical data is transmitted so as to not exceed a bandwidth of the communication line.

7. The method of claim 6, wherein generating graphical data comprises generating graphical data representative of a line entered using a touch-sensitive display.

8. The method of claim 6, wherein identifying discrete data points comprises identifying data points on a periodic basis in which a data point is identified for every predetermined period during user input.

9. The method of claim 6, wherein identifying discrete data points comprises identifying data points on a line length basis in which a data point is identified for every predetermined length of user input.

10. The method of claim 6, further comprising buffering the generated graphical data and identifying new discrete data points that are positioned between the previously identified data points and transmitting the new data points over the communication line.

11. The method of claim 10, further comprising repeating the steps of claim 10 in an iterative process.

12. The method of claim 6, further comprising receiving voice data input via a telephone and transmitting the voice data over the communication line simultaneously with the data points.

13. A method for displaying graphical data, comprising:
receiving via a communication line discrete data points that represent graphical data;
generating line segments that connect the discrete data points; and
displaying the line segments such that a resultant line is shown that comprises the line segments and that represents a user input entered into another device.

14. The method of claim 13, further comprising receiving via the communication line new discrete data points that are positioned between the previously received discrete data points, generating new line segments that connect the new received data points, and displaying the new line segments such that a new resultant line is shown.

15. The method of claim 14, further comprising repeating the steps of claim 14 in an iterative process.

16. The method of claim 13, further comprising receiving voice data simultaneous to receiving the discrete data points.

17. A method for transmitting graphical data via a communication line, comprising:
generating graphical data representative of a user input;
identifying a reference data point;
transmitting information that describes the reference data point via the communication line;
identifying coordinates of a further data point that identify the location of the further data point relative to the reference data point; and
transmitting the coordinates to another device via the communication line.

18. The method of claim 17, wherein generating graphical data comprises generating graphical data representative of a line entered using a touch-sensitive display.

19. The method of claim 17, further comprising identifying a new reference data point, transmitting information that describes the new reference data point via the communication line, identifying coordinates of another data point that identify the location of the other data point relative to the new reference data point, and transmitting the coordinates via the communication line.

20. The method of claim 17, further comprising receiving voice data input via a telephone and transmitting the voice data over the communication line simultaneously with coordinates.

21. The method of claim 1, 6, or 17, further comprising providing an indication can to the user entering the input that communicates what portion of the input has been transmitted or is currently visible to a recipient.

22. The method of claim 21, wherein providing an indication comprises showing a portion of the input in at least one of a different color, a different grayscale, and a different line thickness.

23. The method of claim 22, further comprising removing the indication after passage of a period of time.

24. A system for sharing graphical data via a communication line, comprising:
means for receiving voice data;
means for generating graphical data representative of a user input entered into a touch-sensitive display; and
means for simultaneously transmitting the voice data and information representative of the generated graphical data via the communication line such that a bandwidth of the communication line is not exceeded.

25. The system of claim 24, wherein the means for transmitting comprise means for buffering the graphical data and means for transmitting portions of the graphical data over the communication line at a controlled rate that does not exceed a predetermined maximum data transfer rate.

26. The system of claim 24, wherein the means for transmitting comprise means for identifying discrete data points of the generated graphical data and means for transmitting only the identified discrete data points over the communication line such less than all of the generated graphical data is transmitted.

27. The system of claim 24, wherein the means for transmitting comprise means for identifying a reference data point, means for transmitting information that describes the reference data point via the communication line, means for identifying coordinates of a further data point that identify the location of the further data point relative to the reference data point, and means for transmitting the coordinates via the communication line.

28. The system of claim 24, further comprising means for receiving via the communication line discrete data points that represent graphical data, means for generating line segments that connect the discrete data points, and means for displaying the line segments such that a resultant line is shown that comprises the line segments and that represents a user input entered into another device.

29. A sketchpad device, comprising:
a processing device;
an input device that is configured to receive voice data;
a user interface with which a user can input information;
an output device that is configured to transmit data; and
memory that includes a sketch program that identifies user input entered via the user interface and that generates graphical data representative of the user input, and a transmission control manager that is configured to, via the output device, simultaneously transmit the voice data and information representative of the generated graphical data via a communication line such that a bandwidth of the communication line is not exceeded.

30. The sketchpad device of claim 29, wherein the input device comprises a telephone jack.

31. The sketchpad device of claim 29, wherein the user interface comprises a touch-sensitive display.

32. The sketchpad device of claim 29, wherein the output device comprises a modem.

33. The sketchpad device of claim 29, wherein the sketch program is further configured to display the generated graphical information to the user.

34. The sketchpad device of claim 29, wherein the transmission control manager is configured to buffer the graphical data and transmit portions of the graphical data over the communication line at a controlled rate that does not exceed a predetermined maximum data transfer rate.

35. The sketchpad device of claim 29, wherein the transmission control manager is configured to identify discrete data points of the generated graphical data and transmit only the identified discrete data points over the communication line such less than all of the generated graphical data is transmitted.

36. The sketchpad device of claim 29, wherein the transmission control manager is configured to identify a reference data point, transmit information that describes the reference data point via the communication line, identify coordinates of a further data point that identify the location of the further data point relative to the reference data point, and transmit the coordinates via the communication line.

37. The sketchpad device of claim 29, wherein the transmission control manager is further configured to receive via the communication line discrete data points that represent graphical data, generate line segments that connect the discrete data points, and display the line segments such that a resultant line is shown that comprises the line segments and that represents a user input entered into another sketchpad device.

38. A system stored on a computer-readable medium, the system comprising:
logic configured to receive voice data;
logic configured to generate graphical data representative of a user input; and
logic configured to simultaneously transmit the voice data and information representative of the generated graphical data via a communication line such that a bandwidth of the communication line is not exceeded.
